(19) United States
(12) Patent Application Publication
(10) Pub. No.: US 2024/0020894 A1
(43) Pub. Date: Jan. 18, 2024

(54) DISPLAY CONTROL DEVICE, DISPLAY CONTROL METHOD, DISPLAY CONTROL PROGRAM

(71) Applicant: Nippon Telegraph and Telephone Corporation, (US)

(72) Inventors: Sayaka YAGI, Musashino-shi, Tokyo (JP); Kimio TSUCHIKAWA, Musashino-shi, Tokyo (JP); Haruo OISHI, Musashino-shi, Tokyo (JP); Fumihiro YOKOSE, Musashino-shi, Tokyo (JP); Yuki URABE, Musashino-shi, Tokyo (JP)

(21) Appl. No.: 18/036,028

(22) PCT Filed: Nov. 12, 2020
(86) PCT No.: PCT/JP2020/042270

§ 371 Date: May 9, 2023

(51) Int. Cl. G06T 11/20

(52) U.S. Cl. CPC G06T 11/206

(57) ABSTRACT

A display control device sets a node on the basis of history information of an operation performed by a user using a terminal device and generates a graph object in which a transition between nodes is expressed as a link. The display control device detects a main flow in which nodes having predetermined features are connected to each other among a plurality of nodes included in the graph object and calculates importance of the nodes included in the graph object. The display control device displays a flow in which the nodes included in the graph object are summarized on the basis of the importance of the nodes and a distance to a node in the main flow.

### TECHNICAL FIELD

The present invention relates to a display control device, a display control method, and a display control program.

### BACKGROUND ART

In order to effectively improve business, it is necessary for an analyst to accurately ascertain a business state. In the related art, there has been proposed a method of acquiring and visualizing an operation log of a terminal device, thereby eliminating dependency on a person, and enabling efficient and wide-ranging recognition of a fine-grained business state.

Among visualization methods using operation logs, for example, a visualization method (hereinafter, node-link type display) in which work or an operation is represented as one node and a transition between nodes is represented as a link is known as an effective method for ascertaining a flow of work or an operation. Here, “operation” refers to an operation performed by a user, such as “input of a customer name” or “pressing of a confirmation button”, and “work” refers to an operation group for performing a specific purpose, such as “input to an application system” and “checking of a slip”. In Non Patent Literature 1, for an operation log including information regarding a plurality of granularities such as an application, a window, and operation content, node-link type display in which an operation or the like is represented as a node is realized.

### CITATION LIST

### Non Patent Literature

Non Patent Literature 1: F. Yokose, Y. Urabe, S. Yagi, K. Tsuchikawa, T. Masuda, and H. Oishi, “Operation-visualization Technology to Support Digital Transformation”, NTT Technical Review, vol. 18, no. 5, pp. 43-48, 2020.
Non Patent Literature 2: Y. Urabe, S. Yagi, K. Tsuchikawa, & T. Masuda, Visualizing User Action Data to Discover Business Process, In 2019 20th Asia-Pacific Network Operations and Management Symposium (APNOMS), IEEE, T. 2019, September.

### SUMMARY OF INVENTION

### Technical Problem

Here, in a case where data of an operation log to be handled becomes large-scale, the number of nodes and links to be drawn increases in the conventional node-link type display, and it is difficult to express a connection relationship between nodes in a way that is easy for a user to visually recognize.

In order to cope with this problem, the method in Non Patent Literature 1 realizes, by filtering only a flow of main operation (hereinafter, a main flow), a function of easily observing the main flow.

On the other hand, in the business analysis, there may be a case where it is desired to simultaneously ascertain flows other than the main flow. For example, in a case where it is desired to find a location to which robotic process automation (RPA) is applied, it is assumed that analysis is performed according to a flow of ascertaining a flow of standard and typical operations, and determining whether or not to apply an RPA tool while checking the presence or absence of a branch.

However, in the method in Non Patent Literature 1, only the main flow can be observed in a state in which the filtering is applied, and in order to ascertain the overview including the presence or absence of branching from the main flow, it is necessary to perform observation in a state in which the filtering is canceled, and thus there is a problem that display becomes complicated and reading is difficult in a case where the data to be handled is large-scale.

FIG. 10 is a diagram illustrating a problem in Non Patent Literature 1. In FIG. 10, graphs 5A and 5B are illustrated. In the graph 5A, filtering is applied in the node-link type display, and only a main flow can be observed. On the other hand, the graph 5B is obtained by canceling the filtering in the node-link type display. In a case where the operation log data is large-scale, the display of the graph 5B becomes complicated.

The present invention has been made in view of these circumstances, and an object thereof is to provide a display control device, a display control method, and a display control program capable of displaying a connection relationship between nodes centered on a main flow while maintaining visibility even for large-scale operation log data.

### Solution to Problem

In order to solve the above problems and achieve the object, according to the present invention, there is provided a display control device including a generation unit that sets a node on the basis of history information of an operation performed by a user using a terminal device and generates a graph object in which a transition between nodes is expressed as a link; a calculation unit that detects a main flow in which nodes having predetermined features are connected to each other among a plurality of nodes included in the graph object and calculates importance of the nodes included in the graph object; and a display control unit that displays a flow in which the nodes included in the graph object are summarized on the basis of the importance of the nodes and a distance to a node in the main flow.

### Advantageous Effects of Invention

According to the present invention, it is possible to display a connection relationship between nodes centered on a main flow while maintaining visibility even for large-scale operation log data.

### BRIEF DESCRIPTION OF DRAWINGS

FIG. 1 is a diagram illustrating an example of node-link type display by a display control device according to the present embodiment.

FIG. 2 is a functional block diagram illustrating a configuration of the display control device according to the present embodiment.

FIG. 3 is a diagram illustrating an example of a data structure of an operation log file.

FIG. 4 is a diagram illustrating an example of a data structure of index setting information.

FIG. 5 is a diagram illustrating an example of a data structure of a graph object.

FIG. 6 is a diagram for describing processing of a calculation unit.

FIG. 7 is a diagram for describing processing of a display control unit.

FIG. 8 is a flowchart illustrating a processing procedure of the display control device according to the present embodiment.

FIG. 9 is a diagram illustrating an example of a computer that executes a display control program.

FIG. 10 is a diagram illustrating a problem in Non Patent Literature 1.

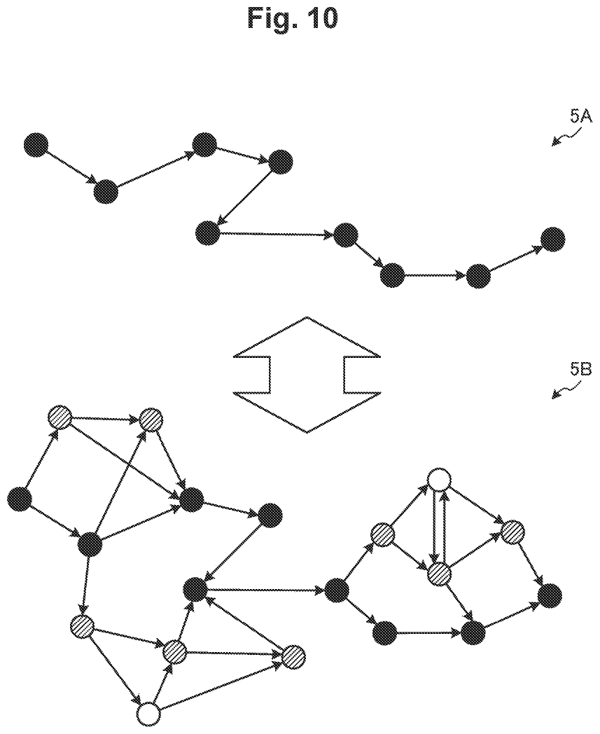

### DESCRIPTION OF EMBODIMENTS

Hereinafter, embodiments of a display control device, a display control method, and a display control program disclosed in the present application will be described in detail with reference to the drawings. The present invention is not limited by the embodiments.

### EMBODIMENT

A display control device according to the present embodiment performs node-link type display in which work or an operation is expressed as one node and a transition between nodes is expressed as a link on the basis of an operation log file. The operation log file is information indicating a history of work or an operation performed on a terminal device when a user performs business.

Here, in a case of performing the node-link type display, the display control device calculates importance of nodes on the basis of features of the nodes, and draws a transition of a node having a high importance as a main flow in a straight line. The display control device summarizes and draws links branching from the main flow according to a detail level. The detail level is designated by a user.

The display control device sets an importance for a node by dividing the node into a predetermined number of nodes. For example, a case where the display control device sets an importance 1, an importance 2, or an importance 3 for a node will be described, but the present invention is not limited thereto. In the present embodiment, as an example, a magnitude relationship of the importance is set as the importance 1>the importance 2>the importance 3. The display control device increases the importance of a node as a distance to a node included in the main flow becomes shorter.

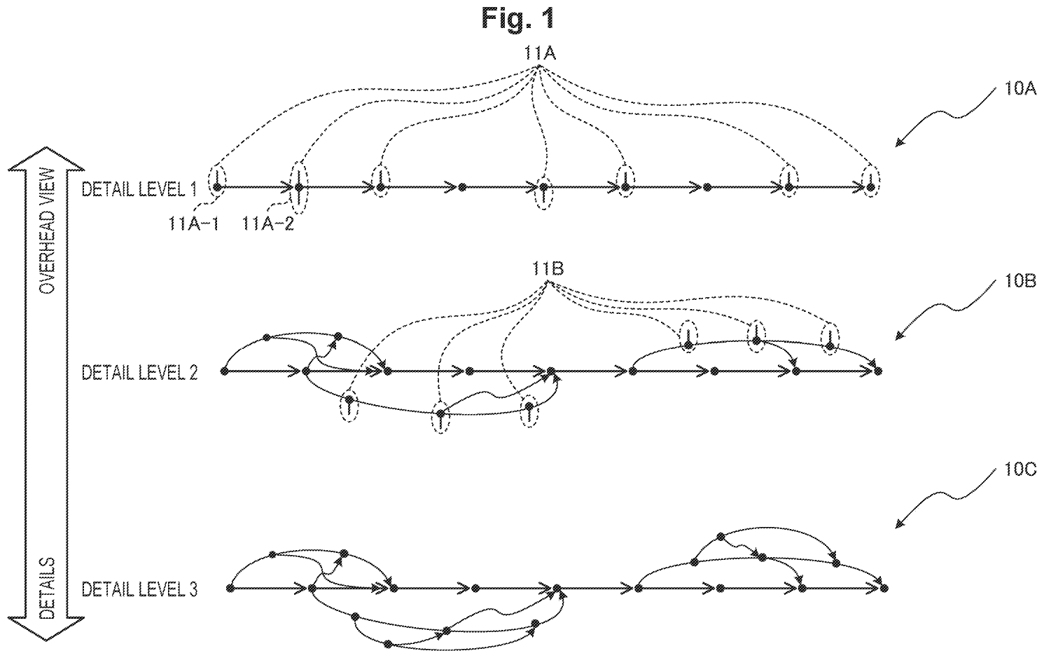

FIG. 1 is a diagram illustrating an example of node-link type display by the display control device according to the present embodiment. For example, in a case where a detail level 1 is designated, the display control device displays a graph 10A indicating a transition of a node for which the importance 1 is set. The transition of the node in the graph 10A corresponds to the main flow. In the graph 10A, in a case where the node having the importance 1 is connected to a node other than the node having the importance 1, branches due to such connection are displayed in an identifiable manner. For example, in the graph 10A, a branch portion 11A is illustrated. In the branch portion 11A, a branch portion 11A-1 indicates that the number of branches from the node is 1. On the other hand, a branch portion 11A-2 indicates that the number of branches from the node is 2.

In a case where the detail level 2 is designated, the display control device displays a graph 10B indicating a transition of nodes for which the importance 1 and 2 are set. In the graph 10B, in a case where the node having the importance 2 is connected to a node other than the nodes having the importance 1 and 2, branches due to such connection are displayed in an identifiable manner. For example, in the graph 10B, a branch portion 11B is illustrated.

In a case where the detail level 3 is designated, the display control device displays a graph 10C indicating a transition of nodes for which the importance 1, 2, and 3 are set.

As illustrated in FIG. 1, according to the display control device of the present embodiment, an importance is set for a node, and a graph is summarized according to an importance corresponding to a detail level designated by a user. As a result, it is possible to intuitively ascertain an overview of a connection relationship between nodes even in a huge operation log file. Even in a case where large-scale data is applied, a connection (branch portion) to a non-displayed node is displayed in an identifiable manner, and thus business analysis can be efficiently performed without missing a characteristic branch or the like.

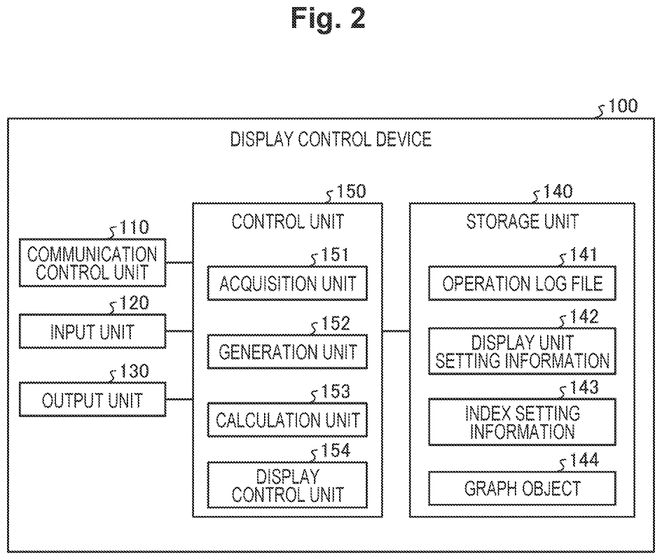

Next, a configuration of the display control device according to the present embodiment will be described. FIG. 2 is a functional block diagram illustrating a configuration of a display control device according to the present embodiment. As illustrated in FIG. 2, a display control device 100 includes a communication control unit 110, an input unit 120, an output unit 130, a storage unit 140, and a control unit 150. The display control device 100 is realized by a general-purpose computer such as a personal computer.

The communication control unit 110 is realized by a network interface card (NIC) or the like, and controls communication between an external device and the control unit 150 via a telecommunication line such as a local area network (LAN) or the Internet.

The input unit 120 is realized by using an input device such as a keyboard or a mouse, and inputs various types of instruction information such as processing start to the control unit 150 in response to input operations of an operator. In the present embodiment, the user operates the input unit 120 to designate a detail level related to the node-link type display.

The output unit 130 is an output device that outputs information acquired from the control unit 150, and is realized by a display device such as a liquid crystal display, a printing device such as a printer, or the like.

The storage unit 140 includes an operation log file 141, display unit setting information 142, index setting information 143, and a graph object 144. The storage unit 140 is realized by a semiconductor memory element such as a random access memory (RAM) or a flash memory or a storage device such as a hard disk or an optical disc.

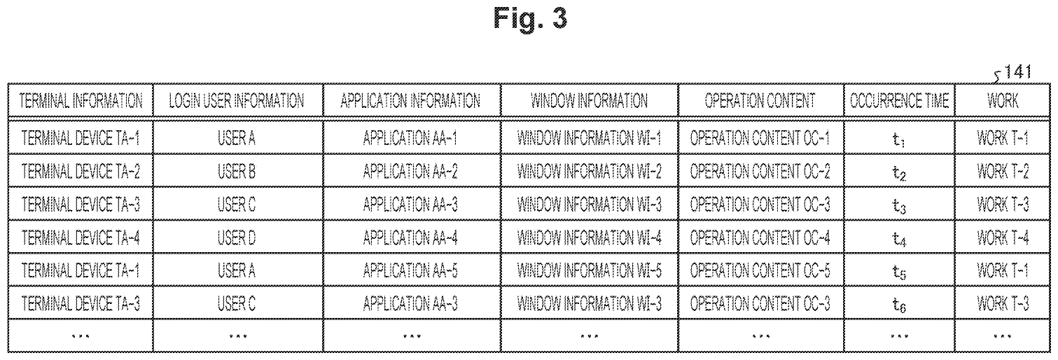

The operation log file 141 is information indicating a history of work or an operation performed on a terminal device in a case where a user performs business. FIG. 3 is a diagram illustrating an example of a data structure of the operation log file. As illustrated in FIG. 3, the operation log file 141 includes terminal information, login user information, application information, window information, operation content, occurrence time, and work. It is assumed that the work is defined through labeling or the like by an analyst, for example, according to the method in Non Patent Literature 2.

The terminal information is information for identifying a terminal device used by a user for business. The login user information is information for identifying a user who has logged in to the terminal device. The application information is information regarding an application used by the user for business.

The window information is, for example, information regarding a window title, a uniform resource locator (URL), a file path, a window handle, or the like. The operation content corresponds to an operation target, an operation type, a value, a captured image, or the like. The operation target is an identifier of an object included in an operation target window. An object in the window corresponds to a button, an input form, or the like. In a case of a browser, an ID or a name attribute may be used, or coordinate information may be used as long as a screen structure of a window does not change. The operation log is recorded when an operation on an operation target occurs. The occurrence time indicates a time at which an operation occurred. The work indicates the content of the work.

The display unit setting information 142 is information defining in which unit a node is generated and the graph object 144 is generated among the data items included in the operation log file 141. For example, in a case where an “operation target” of the data item “operation content” is set in the display unit setting information 142, a control unit 150 that will be described later sets nodes in units of operations, and the nodes are connected in the order of occurrence of the operations.

In a case where the data item “work” is set in the display unit setting information 142, the control unit 150 that will be described later sets nodes in units of work, and the nodes are connected in the order of occurrence of the work. The work is a combination of a plurality of operations, and a combination of the operations is different for each type of work.

Although description is omitted, in the display unit setting information 142, the unit of a node may be defined by a data item other than the above items.

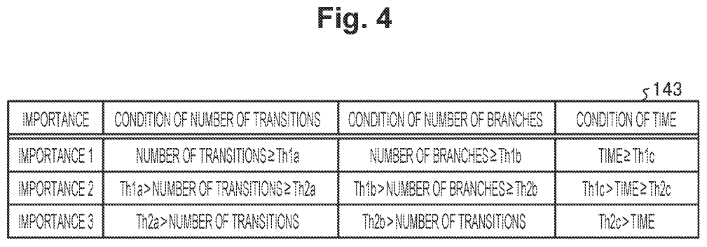

The index setting information 143 is information defining a feature or a combination of features of the operation log file 141 used to calculate an importance of a node. FIG. 4 is a diagram illustrating an example of a data structure of the index setting information. In the example illustrated in FIG. 4, the importance is determined according to a condition of the number of transitions, a condition of the number of branches, and a condition of time. The condition of the number of transitions, the condition of the number of branches, and the condition of time may be changed as appropriate according to the purpose of analysis, or other features may be used.

The number of transitions indicates the number of transitions from a first node that is a transition source to a second node that is a transition destination. An example of the definition of the number of transitions will be described. The first node is a node corresponding to a first operation, and the second node is a node corresponding to a second operation. Here, in a case where the user performs the second operation n_{A} times after the first operation, the number of transitions related to the first node is “n_{A}”.

The number of branches indicates the number of branches of a node. An example of the definition of the number of branches will be described. When the number of second nodes that transition from the first node that is a transition source and have a distance of 1 from the first node is n_{B}, the number of branches related to the first node is “n_{B}”.

The time indicates the time required for transition from the first node that is a transition source to the second node that is a transition destination. An example of the definition of time will be described. In a case where the occurrence time of the first operation corresponding to the first node is tₐ₁, the occurrence time of the second operation corresponding to the second node is tₐ₂, and a transition from the first operation to the second operation occurs n times, the time related to the first node is “Σ(tₐ₂−tₐ₁)/n”.

A process of calculating the importance of a node on the basis of the index setting information 143 will be described later.

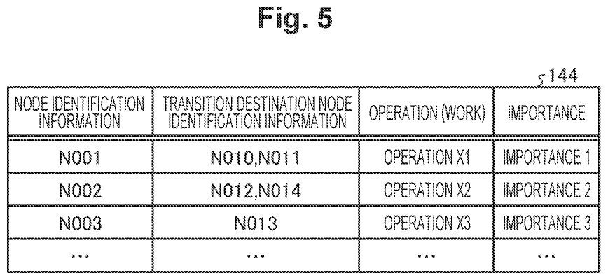

The graph object 144 holds information of each node displayed in a node-link type. FIG. 5 is a diagram illustrating an example of a data structure of the graph object. Here, a data structure of the graph object 144 in a case where the “operation target” of the data item “operation content” is set in the display unit setting information 142 will be described. As illustrated in FIG. 5, the graph object 144 associates node identification information, transition destination node identification information, an operation, and an importance with each other.

The node identification information is information for identifying a node that performs the node-link type display. The transition destination node identification information is information for identifying a node that is a transition destination. The operation indicates an operation corresponding to a node. The importance indicates the importance of a node. For example, it is indicated that a node with the node identification information “N001” is a node corresponding to “operation X1”, a transition destination of the node with the node identification information “N001” is a node with the node identification information “N010” and a node with the node identification information “N011”, and the importance is the “importance 1”.

Although not illustrated in FIG. 5, in a case where the data item “work” is set in the display unit setting information 142, the “work” is associated with the node identification information instead of the “operation”.

The description returns to FIG. 2. The control unit 150 includes an acquisition unit 151, a generation unit 152, a calculation unit 153, and a display control unit 154. The control unit 150 corresponds to a central processing unit (CPU) or the like.

The acquisition unit 151 acquires the operation log file 141 and stores the acquired operation log file 141 in the storage unit 140. The acquisition unit 151 may acquire the operation log file 141 from an external device via the communication control unit 110 or from the input unit 120.

The generation unit 152 generates the graph object 144 on the basis of the operation log file 141 and the display unit setting information 142. The generation unit 152 stores the generated graph object 144 in the storage unit 140.

An example of processing of the generation unit 152 will be described. In a case where an “operation target” of the data item “operation content” is set in the display unit setting information 142, the generation unit 152 sets nodes in units of operation targets on the basis of the operation log file 141, and specifies a connection relationship (flow) of the nodes according to an occurrence order of the operations. In a case where there is a plurality of the same operations, the generation unit 152 integrates the operations into the same node. The generation unit 152 sets node identification information for each node. In a case of setting the node identification information, the generation unit 152 also specifies an operation corresponding to the node identification information.

In a case where the data item “work” is set in the display unit setting information 142, the generation unit 152 sets nodes in units of work on the basis of the operation log file 141, and specifies a connection relationship (flow) of the nodes according to an occurrence order of the work. The work is a combination of a plurality of operations, and a combination of the operations is different for each type of work. In a case where there is a plurality of the same types of work, the generation unit 152 integrates the same types of work into the same node. The generation unit 152 sets node identification information for each node. In a case of setting the node identification information, the generation unit 152 also specifies work corresponding to the node identification information.

The generation unit 152 specifies a relationship between the node identification information and the transition destination node identification information on the basis of the connection relationship of the nodes. The generation unit 152 sets the node identification information, the transition destination node identification information, and the operation (or work) in the graph object 144. The importance of the graph object 144 is calculated by the calculation unit 153 that will be described later.

The calculation unit 153 is a processing unit that calculates the importance of a node on the basis of a feature of the node corresponding to the node identification information included in the graph object 144 and the index setting information 143. The calculation unit 153 registers the calculated importance in the graph object 144.

An example of processing of the calculation unit 153 will be described. Here, it is assumed that nodes are set in units of “operations”. First, the calculation unit 153 specifies a node (node identification information) with the “importance 1” on the basis of a feature of the node and the index setting information 143. The node having the importance 1 is a node included in the main flow.

The calculation unit 153 specifies the number of transitions, the number of branches, and time on the basis of the first operation corresponding to the node identification information of the first node that is a transition source, the second operation corresponding to the node identification information of the second node that is a transition destination, and the operation log file 141. In a case where the specified number of transitions, number of branches, and time satisfy the condition of the number of transitions, the condition of the number of branches, and the condition of time corresponding to the importance 1 in the index setting information 143 described in FIG. 4, the calculation unit 153 specifies that an importance corresponding to the node identification information of the first node is the “importance 1”.

The calculation unit 153 may specify that an importance corresponding to the node identification information of the first node is the “importance 1” in a case where any one of the condition of the number of transitions, the condition of the number of branches, and the condition of time corresponding to the importance 1 in the index setting information 143 is satisfied. Regarding the importance 1, the number of conditions to be satisfied is set in advance by an administrator.

After specifying the node having the importance 1 included in the main flow, the calculation unit 153 determines an importance on the basis of a connection relationship with the main flow, or the condition of the number of transitions, the condition of the number of branches, and the condition of time similarly to the node having the importance 1.

First, processing in a case where the calculation unit 153 determines an importance on the basis of the connection relationship with the main flow will be described. The calculation unit 153 specifies an importance of another node on the basis of a distance to the node having the importance 1. The calculation unit 153 sets an importance of a node adjacent to the node having the importance 1 to the “importance 2”. The calculation unit 153 sets an importance of a node that is not adjacent to the node having the importance 1 but is adjacent to the node having the importance 2 to the “importance 3”.

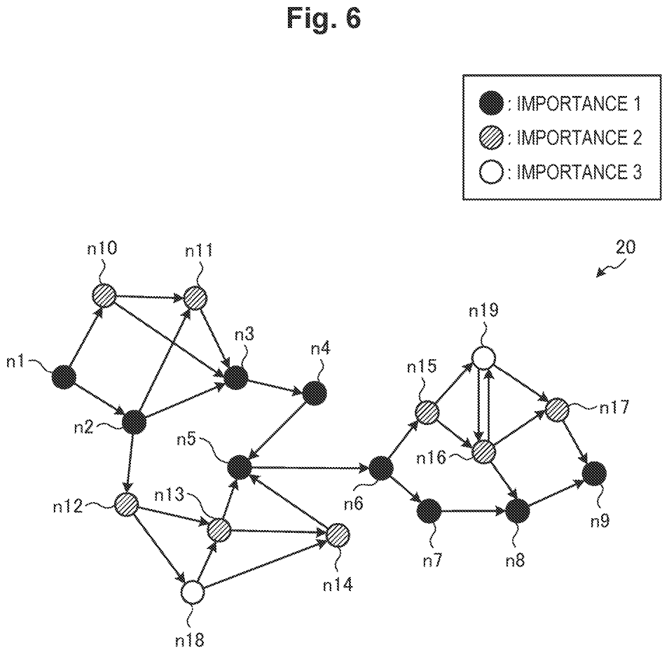

FIG. 6 is a diagram for describing processing of the calculation unit. A graph 20 illustrated in FIG. 6 is a graph visualizing the graph object 144. Nodes n1, n2, n3, n4, n5, n6, n7, n8, and n9 included in the graph 20 are nodes corresponding to the importance 1. A flow of operations specified by the node n1 to the node n9 is the main flow.

Since a node n10 is adjacent to the node n1 having the importance 1, the calculation unit 153 sets an importance of the node n10 to the “importance 2”. Similarly, since nodes n11, n12, n13, n14, n15, n16, and n17 are adjacent to the node having the importance 1, the calculation unit 153 sets importance of the nodes n11 to n17 to the “importance 2”.

Since a node n18 is adjacent to the node n12 (n13, n14) having the importance 2 and is not adjacent to the node having the importance 1, the calculation unit 153 sets an importance of the node n18 to the “importance 3”. Since a node n19 is adjacent to the node n15 (n16, n17) having the importance 2 and is not adjacent to the node having the importance 1, the calculation unit 153 sets an importance of the node n19 to the “importance 3”.

The calculation unit 153 calculates an importance corresponding to a node (node identification information) by executing the above processing, and sets the importance in the graph object 144.

Next, a case where the calculation unit 153 determines an importance on the basis of the condition of the number of transitions, the condition of the number of branches, and the condition of time will be described. Similarly to the case of the importance 1, the calculation unit 153 specifies a node (node identification information) having the importance 2 or the importance 3 on the basis of the index setting information 143. In this case, the calculation unit 153 specifies the number of transitions, the number of branches, and the time for nodes other than a node having the importance 1.

In a case where the specified number of transitions, number of branches, and time satisfy the condition of the number of transitions, the condition of the number of branches, and the condition of time corresponding to the importance 2, the calculation unit 153 specifies that an importance corresponding to the node identification information of the corresponding node is the “importance 2”. The calculation unit 153 may specify that the importance corresponding to the node identification information of the corresponding node is the “importance 2” in a case where any one of the condition of the number of transitions, the condition of the number of branches, and the condition of time corresponding to the importance 2 in the index setting information 143 is satisfied. Regarding the importance 2, the number of conditions to be satisfied is set in advance by the administrator.

In a case where the specified number of transitions, number of branches, and time satisfy the condition of the number of transitions, the condition of the number of branches, and the condition of time corresponding to the importance 3, the calculation unit 153 specifies that the importance corresponding to the node identification information of the corresponding node is the “importance 3”. The calculation unit 153 may specify that the importance corresponding to the node identification information of the corresponding node is the “importance 3” in a case where any one of the condition of the number of transitions, the condition of the number of branches, and the condition of time corresponding to the importance 3 in the index setting information 143 is satisfied. Regarding the importance 3, the number of conditions to be satisfied is set in advance by the administrator.

The display control unit 154 displays a graph summarizing the nodes on the basis of the importance of the nodes set in the graph object 144. For example, the display control unit 154 accepts designation of a detail level from the input unit 120, and displays a graph corresponding to the accepted detail level.

Here, in a case where the calculation unit 153 determines an importance on the basis of the connection relationship with the main flow, the display control unit 154 associates the importance 1 with the detail level 1, associates the importance 2 with the detail level 2, and associates the importance 3 with the detail level 3.

On the other hand, in a case where the calculation unit 153 determines an importance on the basis of the condition of the number of transitions, the condition of the number of branches, and the condition of time, since the detail level 1 displays only the main flow, the display control unit 154 associates a node in the main flow (a node having the importance 1) with the detail level 1. The display control unit 154 associates the detail level 2 with a node having a distance from the main flow equal to or less than a first threshold value among nodes having the importance 2. The display control unit 154 associates the detail level 3 with a node having a distance from the main flow equal to or less than a second threshold value among nodes having the importance 3 (and summarized nodes having the importance 2).

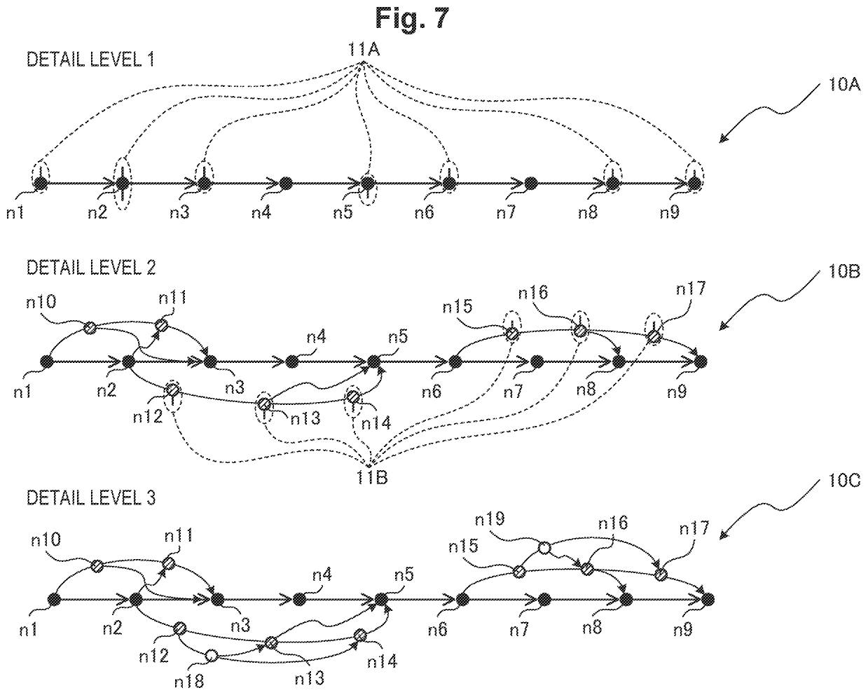

FIG. 7 is a diagram for describing processing of the display control unit. In a case where the “detail level 1” is designated, the display control unit 154 specifies the node identification information having the importance 1 on the basis of the graph object 144, and generates a graph 10A on the basis of a connection relationship between nodes corresponding to the specified node identification information. In the example illustrated in FIG. 7, nodes having the importance 1 are nodes n1 to n9.

The display control unit 154 arranges and connects the nodes n1 to n9 in order in a straight line. Since the nodes n1, n2, n3, n5, n6, n8, and n9 branch into nodes having the importance 2, the display control unit 154 sets a branch portion 11A indicating the branch. The display control unit 154 executes such processing to generate a graph 10A. The display control unit 154 displays the graph 10A on the output unit 130.

In a case where the “detail level 2” is designated, the display control unit 154 specifies node identification information having the importance 1 and 2 on the basis of the graph objects 144, and generates a graph 10B on the basis of a connection relationship between nodes corresponding to the specified node identification information items. In the example illustrated in FIG. 7, the nodes having the importance 2 are nodes n10 to n17. The display control unit 154 arranges and connects the nodes n1 to n9 in order in a straight line similarly to the case of the detail level 1.

The display control unit 154 connects the nodes n1, n10, n11, and n3 in this order according to the connection relationship. The display control unit 154 connects the nodes n2 and n11 according to the connection relationship.

The display control unit 154 connects the nodes n2, n12, n13, n14, and n5 in order according to the connection relationship. The display control unit 154 connects the nodes n13 and n5 according to the connection relationship.

The display control unit 154 connects the nodes n6, n15, n16, n17, and n9 in order according to the connection relationship. The display control unit 154 connects the nodes n16 and n9 according to the connection relationship.

Since the nodes n12, n13, n14, n15, n16, and n17 branch into the nodes having the importance 3, the display control unit 154 sets a branch portion 11B indicating a branch. The display control unit 154 executes such processing to generate a graph 10B. The display control unit 154 displays the graph 10B on the output unit 130.

In a case where the “detail level 3” is designated, the display control unit 154 specifies the node identification information items of the importance 1, 2, and 3 on the basis of the graph objects 144, and generates the graph 10C on the basis of the connection relationship among the nodes of the specified node identification information item. In the example illustrated in FIG. 7, the nodes having the importance 3 are as nodes n18 and n19. The display control unit 154 arranges and connects the nodes n1 to n9 in order in a straight line similarly to the case of the detail level 1. The display control unit 154 connects the nodes n10 to n17 similarly to the case of the detail level 2.

The display control unit 154 connects the nodes n12, n18, and n14 in this order according to the connection relationship. The display control unit 154 connects n18 and n13 according to the connection relationship.

The display control unit 154 connects the nodes n6, n19, and n17 in this order according to the connection relationship. The display control unit 154 connects n19 and n16 according to the connection relationship. The display control unit 154 executes such processing to generate a graph 10C. The display control unit 154 displays the graph 10C on the output unit 130.

Incidentally, details of the processing of the display control unit 154 described above are examples. For example, the display control unit 154 may first determine disposition (coordinate values) of nodes in a state in which summarization is not performed (the detail level 3 in the example of FIG. 7), then determine a node to be drawn on the basis of the detail level, and perform display. For example, in a case where the detail level 1 or the detail level 2 is designated, the display control unit 154 displays flows related to the importance 1 and 2 and branch lines (for example, 11A and 11B) on the basis of the determined coordinate values.

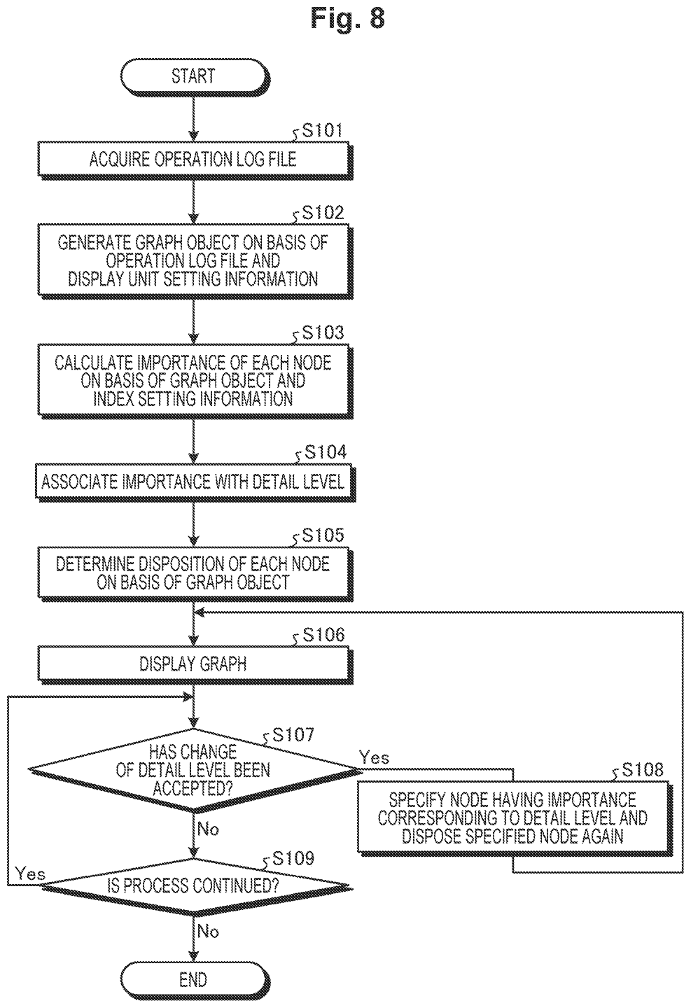

Next, an example of a processing procedure of the display control device 100 according to the present embodiment will be described. FIG. 8 is a flowchart illustrating a processing procedure of the display control device according to the present embodiment. As illustrated in FIG. 8, the acquisition unit 151 of the display control device 100 acquires the operation log file 141 (step S101).

The generation unit 152 of the display control device 100 generates the graph object 144 on the basis of the operation log file 141 and the display unit setting information 142 (step S102). The calculation unit 153 of the display control unit 154 calculates an importance of each node on the basis of the graph object 144 and the index setting information 143 (step S103).

The display control unit 154 of the display control device 100 associates the importance with the detail level (step S104). The display control unit 154 determines disposition of each node on the basis of the graph object 144 (step S105).

The display control unit 154 displays a graph (step S106). In a case a change of the detail level is accepted from the input unit 120 (step S107, Yes), the display control unit 154 specifies a node having an importance corresponding to the detail level, disposes the specified node again (step S108), and proceeds to step S106.

On the other hand, in a case where a change of the detail level is not accepted (step S107, No), the display control unit 154 proceeds to step S109. In a case where the process is continued (step S109, Yes), the display control unit 154 proceeds to step S107 again. In a case where the process is not continued (step S109, No), the display control unit 154 finishes the process.

Next, effects of the display control device 100 according to the present embodiment will be described. The display control device 100 sets an importance for a node, and summarizes a graph according to an importance corresponding to a detail level designated by a user. As a result, it is possible to intuitively ascertain an overview of a connection relationship between nodes even in a huge operation log file. Even in a case where large-scale data is applied, a connection (branch portion) to a non-displayed node is displayed in an identifiable manner, and thus business analysis can be efficiently performed without missing a characteristic branch or the like.

Since the display control device 100 sets nodes in units of the items defined in the display unit setting information 142, it is possible to generate and display a graph with granularity suitable for the purpose of analysis.

The display control device 100 can intuitively ascertain an overview of an operation flow and a branch centered on a main flow by summarizing flows having a distance equal to or more than a threshold value from the main flow in association with a detail level of a node on the basis of a connection relationship between features (the number of transitions, the number of branches, time, and the like) of the node and the main flow.

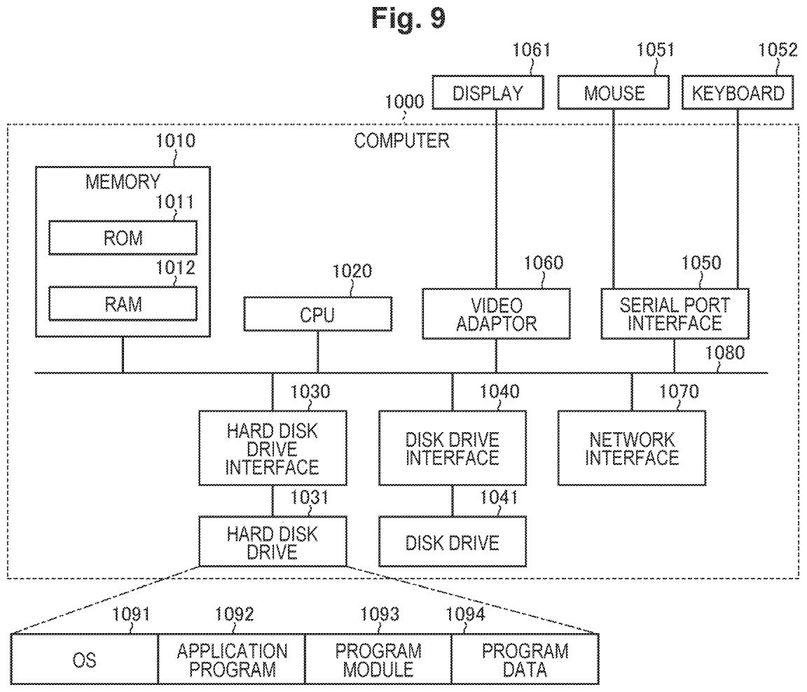

FIG. 9 is a diagram illustrating an example of a computer that executes a display control program. A computer 1000 includes, for example, a memory 1010, a CPU 1020, a hard disk drive interface 1030, a disk drive interface 1040, a serial port interface 1050, a video adapter 1060, and a network interface 1070. These units are connected to each other via a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1031. The disk drive interface 1040 is connected to a disk drive 1041. For example, a removable storage medium such as a magnetic disk or an optical disc is inserted into the disk drive 1041. A mouse 1051 and a keyboard 1052 are connected to, for example, the serial port interface 1050. A display 1061 is connected to, for example, the video adapter 1060.

Here, the hard disk drive 1031 stores, for example, an OS 1091, an application program 1092, a program module 1093, and program data 1094. Each piece of information described in the above embodiment is stored in, for example, the hard disk drive 1031 or the memory 1010.

The display control program is stored in the hard disk drive 1031, for example, as the program module 1093 in which commands to be executed by the computer 1000 are described. Specifically, the program module 1093 in which each process executed by the display control device 100 described in the embodiment is described is stored in the hard disk drive 1031.

Data to be used for information processing performed by the display control program is stored as the program data 1094, for example, in the hard disk drive 1031. The CPU 1020 reads, into the RAM 1012, the program module 1093 and the program data 1094 stored in the hard disk drive 1031 as necessary, and executes each procedure described above.

The program module 1093 and the program data 1094 related to the display control program are not limited to a case of being stored in the hard disk drive 1031, and may be stored in, for example, a removable storage medium and read by the CPU 1020 via the disk drive 1041 or the like. Alternatively, the program module 1093 and the program data 1094 related to the display control program may be stored in another computer connected via a network such as a LAN or a wide area network (WAN), and may be read by the CPU 1020 via the network interface 1070.

Although the embodiments to which the invention made by the present inventor is applied have been described above, the present invention is not limited by the description and the drawings as a part of the disclosure of the present invention according to the embodiments. In other words, other embodiments, examples, operation techniques, and the like made by those skilled in the art and the like on the basis of the embodiments are all included in the scope of the present invention.

### REFERENCE SIGNS LIST

100 Display control device
110 Communication control unit
120 Input unit
130 Output unit
140 Storage unit
141 Operation log file
142 Display unit setting information
143 Index setting information
144 Graph object
150 Control unit
151 Acquisition unit
152 Generation unit
153 Calculation unit
154 Display control unit

1. A display control device comprising one or more processors coupled to a display, wherein the one or more processors are configured to perform operations comprising:
setting a node on a basis of history information of an operation performed by a user using a terminal device and generating a graph object in which a transition between nodes is expressed as a link;
detecting a main flow in which nodes having predetermined features are connected to each other among a plurality of nodes included in the graph object and calculating importance of nodes included in the graph object; and
controlling the display to display a flow in which the nodes included in the graph object are summarized on a basis of the importance of the nodes and a distance to a node in the main flow.

2. The display control device according to claim 1, wherein the one or more processors are configured to set the node on the basis of any of a plurality of items included in the history information.

3. The display control device according to claim 1, wherein the one or more processors are configured to accept index information of an importance that is a display target, specify a node having an importance corresponding to the index information among the nodes included in the graph object, and control the display to display a flow of the specified node.

4. The display control device according to claim 1, wherein the one or more processors are configured to calculate the importance of the nodes included in the graph object by further using an adjacency relationship with an adjacent node, associate an importance with a detail level, and control the display to display a flow according to a specified detail level.

5. A display control method executed by a display control device, comprising:
setting a node on a basis of history information of an operation performed by a user using a terminal device and generating a graph object in which a transition between nodes is expressed as a link;
detecting a main flow in which nodes having predetermined features are connected to each other among a plurality of nodes included in the graph object and calculating importance of the nodes included in the graph object; and
displaying a flow in which the nodes included in the graph object are summarized on a basis of the importance of the nodes and a distance to a node in the main flow.

6. A display control program comprising instructions that, when executed, cause a computer to execute operations comprising:
setting a node on a basis of history information of an operation performed by a user using a terminal device and generating a graph object in which a transition between nodes is expressed as a link;
detecting a main flow in which nodes having predetermined features are connected to each other among a plurality of nodes included in the graph object and calculating importance of the nodes included in the graph object; and
displaying a flow in which the nodes included in the graph object are summarized on a basis of the importance of the nodes and a distance to a node in the main flow.
